(19) United States
(12) Patent Application Publication
(10) Pub. No.: US 2009/0006364 A1
(43) Pub. Date: Jan. 1, 2009

(54) EXTENDING A SEED LIST TO SUPPORT METADATA MAPPING

(75) Inventors: David Konopnicki, Haifa (IL); Laurent D. Hasson, New York, NY (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: INTERNATIONAL BUSINESS MACHINES CORPORATION, Armonk, NY (US)

(21) Appl. No.: 11/770,419

(22) Filed: Jun. 28, 2007

(51) Int. Cl. G06F 7/06; G06F 17/30

(52) U.S. Cl. 707/5; 707/E17.014; 707/E17.008

(57) ABSTRACT

Embodiments of the present invention address deficiencies of the art in respect to crawling content and provide a method, system and computer program product for metadata processing for seed lists for structured content sources. In one embodiment, a method for processing metadata for a seed list can include extracting metadata from a seed list for application content, storing the metadata in a repository, associating the metadata with fields of the application content, crawling the fields of the application content by reference to the metadata, and indexing the fields. In an aspect of the embodiment, the method further can include annotating the application to produce metadata for the fields of the application content. In yet another aspect of the embodiment, the method can include mapping the metadata to a document schema generic to a plurality of heterogeneous application content.

### BACKGROUND OF THE INVENTION

1. Field of the Invention

The present invention relates to the field of content crawling and more particularly to crawling hierarchically structured content sources.

2. Description of the Related Art

The development of the modern computer communications network and the wide-scale adoption of the global Internet as a primary source of information have transformed the way in which information is both generated and also shared amongst individuals. Prior to electronic methods of publishing content, individuals seeking information largely relied upon libraries and personal subscriptions to periodicals, newspapers and journals. By comparison, today one can access vast repositories of data in a matter of minutes that otherwise would consume hours if not days of tedious, manual scouring of print documents.

Even before the popularization of the World Wide Web, information technologists recognized the need to properly index electronic content such that the content can be accessed electronically and remotely by interested parties. Indeed, the very need to access related content led to the development of the hyperlink and markup language formatted documents both of which enabled the acceptance of the World Wide Web. The World Wide Web itself can be viewed as a vast hierarchy of related documents and content, connected through hyperlink relationships all of which can be accessed globally over the Internet. From the very beginning, search engine technologies evolved to address the need to discover and catalog content published and accessible through the World Wide Web.

Search engines generally locate and index content on the World Wide Web and also internally defined networks by parsing content word by word to generate index records correlating the word with a location in a document. In order to automate the discover of available content on the World Wide Web, Internet bots specifically tailored to populate search engine databases commonly are deployed and permitted to “crawl” or “spider” the accessible World Wide Web first locating content, subsequently indexing located content, linking to related content, and repeating the process. Known as crawling or spidering, the foregoing process forms the foundation of modern search engine technologies.

Unlike a general, content crawler, a focused crawler seeks, acquires, indexes, and maintains pages on a specific set of topics that represent a relatively small portion of the World Wide Web. Focused crawlers require a much smaller investment in computing resources and can achieve high coverage of pertinent content at a rapid rate. A focused crawler usually can begin with a seed list that contains uniform resource locators (URLs) that are relevant to a topic of interest. Subsequently, the focused crawler can crawl the URLs and follow the hyperlinks from the pages corresponding to the URLs to identify the most promising hyper links based upon both the content of the source pages and the hyperlink structure of the World Wide Web.

The seed list, then, can resemble a site map of relevant content for a topic of interest. In this regard, site maps directly map to a Web site's entry points. In contrast, a seed list seeks to directly represent content at the application level which differs from the organization of the content at the Web site level. To do this effectively, seed lists mirror application structure and present a hierarchical representation of content as the application originally intended it to be, and not necessarily as a Web site would present the content. Notably, unlike site maps that are used to index Web sites, seed lists that pertain to application data must convey metadata to a crawler with respect to the different fields of the application in order to describe how the metadata must be indexed.

In particular, content metadata recently has experienced rapid growth and must be indexed in the same way as the content itself. As such, content metadata must be indexed in a generic way and harmonized across content types to support disparate, heterogeneous crawlers. Even still, crawlers generally are tightly coupled to respective content protocols, for example different applications often provide a different access protocol to content metadata. Finally, the advent of Web 2.0 has created a chasm between content and content views further elevating the importance of indexing metadata in a generic way.

### BRIEF SUMMARY OF THE INVENTION

Embodiments of the present invention address deficiencies of the art in respect to crawling content and provide a novel and non-obvious method, system and computer program product for metadata processing for seed lists for structured content sources. In one embodiment, a method for processing metadata for a seed list can include extracting metadata from a seed list for application content, storing the metadata in a repository, associating the metadata with fields of the application content, crawling the fields of the application content by reference to the metadata, and indexing the fields. In an aspect of the embodiment, the method further can include annotating the application to produce metadata for the fields of the application content. In yet another aspect of the embodiment, the method can include mapping the metadata to a document schema generic to a plurality of heterogeneous application content.

In another embodiment of the invention, a content indexing data processing system can be provided. The system can include a search index and a seed list crawler configured to crawl application content according to a seed list and to index crawled application content in the search index. The system further can include a metadata repository, and metadata processing logic coupled to the seed list crawler. The logic can include program code enabled to extract metadata from the seed list and to store the metadata in the metadata repository in association with fields in the seed list mimicking fields in the application content. Optionally, an annotator can be configured to annotate the seed list to produce metadata for fields in the seed list.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of a content distribution data processing system configured for metadata processing of seed lists for structured content sources; and,

FIG. 2 is a flow chart illustrating a process for metadata processing of seed lists for structured content sources.

### DETAILED DESCRIPTION OF THE INVENTION

Embodiments of the present invention provide a method, system and computer program product for metadata processing of seed lists for structured content sources. In accordance with an embodiment of the present invention, metadata in a seed list can be extracted and stored in a repository. Thereafter, the metadata can be associated with fields for application content represented by the seed list and the metadata can be used by a seed list crawler to index the different associated fields of the application content. Optionally the metadata further can be used to unify content indexed by other applications in that fields may differ in form from application to application and the metadata can provide a unifying definition of the disparate fields.

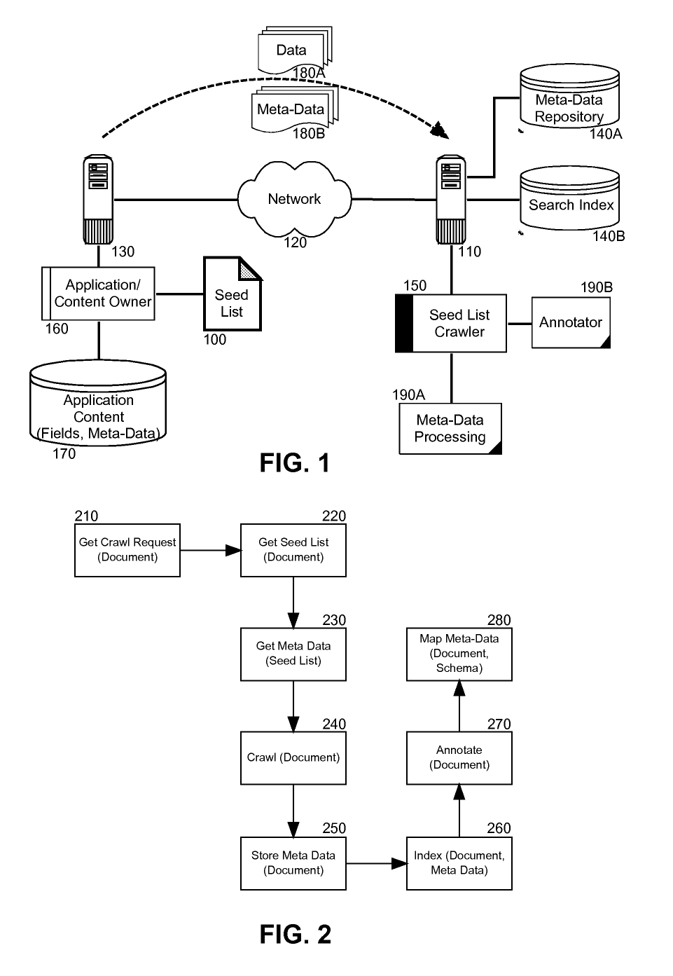

In illustration, FIG. 1 schematically depicts a content distribution data processing system configured for metadata processing of seed lists for structured content sources. The system can include a host computing platform 130 supporting the operation of an application 160 managing application content 170. A seed list 100 further can be provided in association with the application content 170. Finally, the host computing platform 130 can be communicatively coupled to a computer communications network 120, for example the global Internet.

The system also can include a seed list crawler 150. The seed list crawler 150 can operate in a host computing platform 110 and the host computing platform 110 can be communicatively coupled to the computer communications network 120. The seed list crawler 150 can be configured to crawl the application content 170 by reference to the seed list 100. In crawling the application content 170, the seed list crawler 150 can create a search index 140B for the application content 170. Yet further, the seed list crawler 150 can store metadata 180B from the seed list 100 for the application content 170 in the metadata repository 140B and the seed list crawler 150 can create a search index 140B for fields of the application content 170 according to the metadata 180B.

The role of metadata 180B is to make the application content 170 submitted for crawling self describing when custom elements are defined for the application. In particular, metadata 180B provides the seed list crawler 150 with hints about how the fields of the application content 170 are be treated during crawling. To that end, metadata 180B can be defined for different fields of application content 170, including author, summary, title, published, updated as well as user defined fields. Consequently, the definition of fields in the metadata 180B mimics the definition of fields in the application content 170. In any event, the metadata 180B can indicate the name, a description, and a data type for a field, as well as whether the content of the field is searchable and whether the field itself is searchable.

Metadata processing logic 190A can be coupled to the seed list crawler 150. The metadata processing logic 190 can include program code enabled extract the metadata 190B from the seed list 100 for the application content 170 and to map the metadata 180B to different fields in application content 170. An annotator 190B likewise can be coupled to seed list crawler 150 and can include program code enabled to permit end user annotation of the application content 170 to produce the metadata 180B. In either case, optionally the metadata 180B can be mapped to a schema so as to unify application content 170 produced by multiple, different heterogeneous applications irrespective of the precise format and structure of the application content for the different heterogeneous applications.

In more particular illustration, FIG. 2 is a flow chart illustrating a process for metadata processing of seed lists for structured content sources. Beginning in block 210, a crawl request can be received for a document. In block 220, a seed list can be retrieved in association with the document and in block 230, metadata for the document can be extracted from the seed list. In block 240, the document can be crawled according to the seed list in consideration of the metadata. In particular, the seed list can indicate which content to index during crawling, whilst the metadata can indicate the nature of the fields of the document to facilitate the indexing of the fields. Thereafter, in block 250 the metadata can be stored for the document and the document can be indexed in block 260 according to the seed list and metadata.

Optionally, in block 270 the document itself can be manually annotated to specify metadata for the document by providing a user interface allowing an end user to select a field in the document and to specify the metadata for the selected field, such as the name, a description, and a data type, as well as whether the content of the field is searchable and whether the field itself is searchable. As yet a further option, in block 280 the metadata can be mapped to a schema defined generically for all applications so that fields of one application can be mapped identically to like fields of a different application.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A method for processing metadata for a seed list comprising:
extracting metadata from a seed list for application content;
storing the metadata in a repository;
associating the metadata with fields of the application content;
crawling the fields of the application content by reference to the metadata; and,
indexing the fields.

2. The method of claim 1, further comprising annotating the application to produce metadata for the fields of the application content.

3. The method of claim 1, further comprising mapping the metadata to a document schema generic to a plurality of heterogeneous application content.

4. A content indexing data processing system, comprising:
a search index;
a seed list crawler configured to crawl application content according to a seed list and to index crawled application content in the search index;
a metadata repository; and,
metadata processing logic coupled to the seed list crawler, the logic comprising program code enabled to extract metadata from the seed list and to store the metadata in the metadata repository in association with fields in the seed list mimicking fields in the application content.

5. The system of claim 4, further comprising an annotator configured to annotate the seed list to produce metadata for fields in the seed list.

6. A computer program product comprising a computer usable medium embodying computer usable program code for processing metadata for a seed list, the computer program product comprising:
computer usable program code for extracting metadata from a seed list for application content;
computer usable program code for storing the metadata in a repository;
computer usable program code for associating the metadata with fields of the application content;
computer usable program code for crawling the fields of the application content by reference to the metadata; and,
computer usable program code for indexing the fields.

7. The computer program product of claim 6, further comprising computer usable program code for annotating the application to produce metadata for the fields of the application content.

8. The computer program product of claim 6, further comprising computer usable program code for mapping the metadata to a document schema generic to a plurality of heterogeneous application content.
